(19) United States
(12) Patent Application Publication
(10) Pub. No.: US 2026/0098495 A1
(43) Pub. Date: Apr. 9, 2026

(54) GAS TURBINE ENGINE

(71) Applicants: General Electric Company, Evendale, OH (US); GE Aerospace Poland Sp. z o. o., Warsaw (PL); GE Avio S.r.l., Rivalta di Torino (IT)

(72) Inventors: Arthur William Sibbach, Boxford, MA (US); Aleksandra Natalia Grzybowska, Radom (PL); Brandon Wayne Miller, Middletown, OH (US); Dario Mantegazza, Torino (IT)

(21) Appl. No.: 19/207,488

(22) Filed: May 14, 2025

(30) Foreign Application Priority Data
Oct. 8, 2024 (PL) P.449985

(51) Int. Cl. F02C 3/06; B33Y 80/00

(52) U.S. Cl. CPC F02C 3/06; B33Y 80/00

(57) ABSTRACT

A gas turbine engine includes a turbomachine comprising a compressor section, a combustion section, and a turbine section arranged in serial flow order, the compressor section having a compressor, the turbine section having one or more turbines. The turbomachine includes one or more additively manufactured metal components, and a total mass of the one or more additively manufactured metal components is in a range from 1% to 50% of a total dry mass of the gas turbine engine.

### PRIORITY INFORMATION

The present application claims priority to Poland Patent Application Number P.449985 filed on Oct. 8, 2024.

### FIELD

The present disclosure relates to a gas turbine engine.

### BACKGROUND

A gas turbine engine includes a turbomachine. The turbomachine generally includes an inlet, one or more compressors, a combustor, and at least one turbine.

The compressors compress air which is channeled to the combustor where it is mixed with fuel. The mixture is then ignited for generating hot combustion gases. The combustion gases are channeled to the turbine(s) which extracts energy from the combustion gases for powering the compressor(s), as well as for producing useful work to, e.g., propel an aircraft in flight. The turbomachine is mechanically coupled to an output shaft to, in the case of a turboprop engine, drive a propeller assembly of the gas turbine engine during operation.

### BRIEF DESCRIPTION OF THE DRAWINGS

A full and enabling disclosure of the present disclosure, including the best mode thereof, directed to one of ordinary skill in the art, is set forth in the specification, which makes reference to the appended FIG. s, in which:

FIG. 1 is a schematic view of an open rotor gas turbine engine in accordance with an exemplary aspect of the present disclosure.

FIG. 2 is a schematic view of a turbofan gas turbine engine in accordance with an exemplary aspect of the present disclosure.

FIG. 3 is a schematic view of a turboprop gas turbine engine in accordance with an exemplary aspect of the present disclosure.

### DETAILED DESCRIPTION

Reference will now be made in detail to present embodiments of the disclosure, one or more examples of which are illustrated in the accompanying drawings. The detailed description uses numerical and letter designations to refer to features in the drawings. Like or similar designations in the drawings and description have been used to refer to like or similar parts of the disclosure.

The word “exemplary” is used herein to mean “serving as an example, instance, or illustration.” Any implementation described herein as “exemplary” is not necessarily to be construed as preferred or advantageous over other implementations. Additionally, unless specifically identified otherwise, all embodiments described herein should be considered exemplary.

As used herein, the terms “first”, “second”, and “third” may be used interchangeably to distinguish one component from another and are not intended to signify location or importance of the individual components.

The terms “forward” and “aft” refer to relative positions within a gas turbine engine or vehicle, and are based on a normal operational attitude of the gas turbine engine or vehicle. More particularly, forward and aft are used herein with reference to a direction of travel of the vehicle and a direction of propulsive thrust of the gas turbine engine.

The terms “upstream” and “downstream” refer to the relative direction with respect to fluid flow in a fluid pathway. For example, “upstream” refers to the direction from which the fluid flows, and “downstream” refers to the direction to which the fluid flows.

The terms “coupled,” “fixed,” “attached to,” and the like refer to both direct coupling, fixing, or attaching, as well as indirect coupling, fixing, or attaching through one or more intermediate components or features, unless otherwise specified herein.

The singular forms “a”, “an”, and “the” include plural references unless the context clearly dictates otherwise.

The phrases “from X to Y” and “between X and Y” each refers to a range of values inclusive of the endpoints (i.e., refers to a range of values that includes both X and Y).

As described herein, the presently disclosed subject matter involves the use of additive manufacturing machines or systems. As used herein, the term “additive manufacturing” refers generally to manufacturing technology in which components are manufactured in a layer-by-layer manner. An exemplary additive manufacturing machine may be configured to utilize any suitable additive manufacturing technology. The additive manufacturing machine may utilize an additive manufacturing technology that includes a powder bed fusion (PBF) technology, such as a direct metal laser melting (DMLM) technology, a selective laser melting (SLM) technology, a directed metal laser sintering (DMLS) technology, or a selective laser sintering (SLS) technology. In an exemplary PBF technology, thin layers of powder material are sequentially applied to a build plane and then selectively melted or fused to one another in a layer-by-layer manner to form one or more three-dimensional objects. Additively manufactured objects are generally monolithic in nature and may have a variety of integral sub-components.

Additionally or alternatively suitable additive manufacturing technologies may include, for example, Fused Deposition Modeling (FDM) technology, Direct Energy Deposition (DED) technology, Laser Engineered Net Shaping (LENS) technology, Laser Net Shape Manufacturing (LNSM) technology, Direct Metal Deposition (DMD) technology, Digital Light Processing (DLP) technology, and other additive manufacturing technologies that utilize an energy beam or other energy source to solidify an additive manufacturing material such as a powder material. In fact, any suitable additive manufacturing modality may be utilized with the presently disclosed the subject matter.

Additive manufacturing technology may generally be described as fabrication of objects by building objects point-by-point, line-by-line, layer-by-layer, typically in a vertical direction. Other methods of fabrication are contemplated and within the scope of the present disclosure. For example, although the discussion herein refers to the addition of material to form successive layers, the presently disclosed subject matter may be practiced with any additive manufacturing technology or other manufacturing technology, including layer-additive processes, layer-subtractive processes, or hybrid processes.

The additive manufacturing processes described herein may be used for forming components using any suitable material. For example, the material may be metal, ceramic, polymer, epoxy, photopolymer resin, plastic, or any other suitable material that may be in solid, powder, sheet material, wire, or any other suitable form, or combinations thereof. Additionally, or in the alternative, exemplary materials may include metals, ceramics, or binders, as well as combinations thereof. Exemplary ceramics may include ultra-high-temperature ceramics, and/or precursors for ultra-high-temperature ceramics, such as polymeric precursors. Each successive layer may be, for example, between about 10 micrometers (μm) and 200 μm, although the thickness may be determined based on any number of parameters and may be any suitable size.

As used herein, the term “build plane” refers to a plane defined by a surface upon which an energy beam impinges to selectively irradiate and consolidate powder material during an additive manufacturing process. Generally, the surface of a powder bed defines the build plane. During irradiation of a respective layer of the powder bed, a previously irradiated portion of the respective layer may define a portion of the build plane. Prior to distributing powder material across a build module, a build plate that supports the powder bed generally defines the build plane.

As used herein, the term “consolidate” or “consolidating” refers to solidification of powder material as a result of irradiating the powder material, including by way of melting, fusing, sintering, or the like.

The “total dry mass” of a gas turbine engine may be defined as being the mass of the entire gas turbine engine, excluding fluids (such as oil and fuel), prior to installation of the gas turbine engine onto an aircraft or aeronautical vehicle, and not including a nacelle or a thrust reverser.

The present disclosure is directed to gas turbine engines configured as a turbofan engine, open rotor engine, or turboprop engine. Generally, a turbofan engine includes a fan and a turbomachine, with the turbomachine rotating the fan to generate thrust. The turbomachine includes a compressor section, a combustion section, a turbine section, and an exhaust section and defines a working gas flowpath therethrough. A relatively small amount of thrust may also be generated by an airflow exiting the working gas flowpath of the turbomachine through the exhaust section. In addition, certain turbofan engines may further include a third stream that contributes to a total thrust output of the turbofan engine, potentially allowing for a reduction in size of a core of the turbomachine for a given total turbofan engine thrust output. Turboprop engines generally include a turbomachine, the turbomachine including a compressor section, a combustion section, a turbine section, and defining a working gas flowpath therethrough. The power generated by the turbomachine is transmitted to a load, e.g., a propeller in the case of a turboprop engine, through an output shaft. In such a manner, for turboprop engines, the output shaft causes the propeller rotor blades to rotate and generate a thrust output. Thus, as used herein, a “gas turbine engine” shall not be considered to include a turboshaft engine.

In certain exemplary embodiments, the present inventors have found that providing a gas turbine engine with a total mass of additively manufactured metal components in the ranges defined herein, which is greater than conventional gas turbine engines, provides weight-savings and efficiencies of scale such as, by way of non-limiting example, components of reduced size requiring fewer attachment locations and coupling mechanisms. Additionally, providing a gas turbine engine with a total mass of additively manufactured metal components in the ranges defined herein reduces accessibility requirements for component installation or removal, and balances the cost of producing additively manufactured metal components with time constraints with the development and certification of component design modifications.

In exemplary embodiments, a total mass of additively manufactured metal components in the gas turbine engine is in a range from 1% to 50% of a total dry mass of the gas turbine engine. Embodiments of the present disclosure are applicable at least to a gas turbine engine being a turboprop engine configured to provide a range of 300-8,000 Horsepower, a ducted turbofan engine configured to provide a range of 3,000-125,000 pounds thrust, or an open rotor engine configured to provide a range of 5,000-60,000 pounds thrust. The present inventors have found that providing a gas turbine engine with a total mass of additively manufactured metal components in the ranges defined herein are advantageous in gas turbine engines having at least one of a design life of greater than 500 hours or 500 flight cycles before overhaul. The inventors of the present disclosure have found that DMLM machines are limited in the size of parts that can be produced such that such additively manufactured parts may be limited for use in areas with a smaller envelope. Further, additive manufacturing techniques such as binder jet may be of limited applicability in a gas turbine engine due to porosity within the part from the binder jet process. The inventors of the present disclosure have found that components within a flowpath diameter of a gas turbine engine are exemplary candidates for additively manufactured metal components such as, by way of non-limiting example, DMLM processes including cobalt as a material. Thus, the inventors of the present disclosure have found that a selection of non-rotating additively manufactured metal components for a gas turbine engine fabricated using additive manufacturing techniques such as, by way of non-limiting example, DMLM, with a total mass in the ranges defined herein provides weight-savings and components of reduced size as one or more of such components can be combined or integrated into a single component requiring fewer attachment locations and coupling mechanisms and less accessibility requirements for component installation or removal.

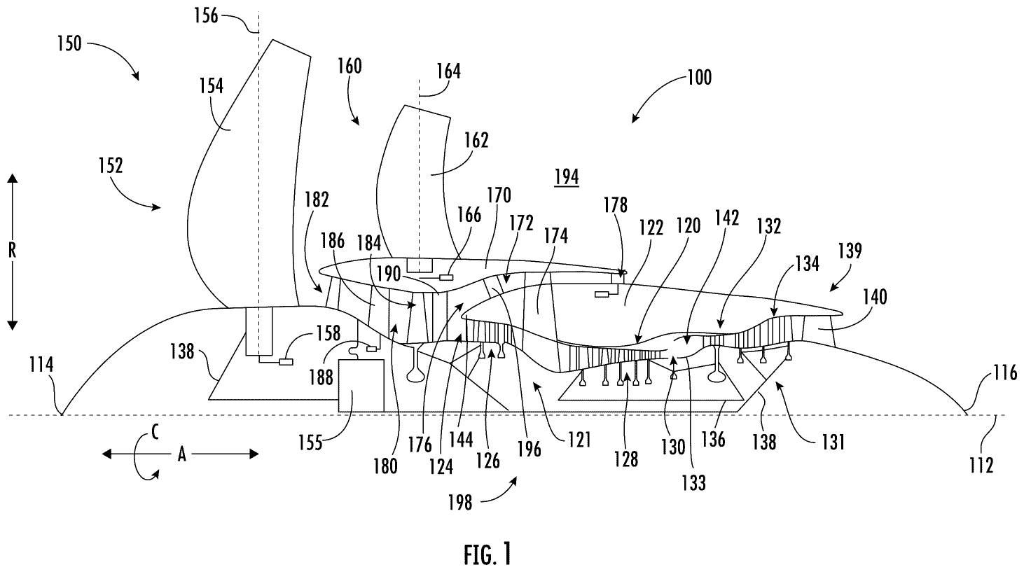

Referring now to FIG. 1, a schematic cross-sectional view of a gas turbine engine 100 is provided according to an example embodiment of the present disclosure. Particularly, FIG. 1 provides a turbofan engine having a rotor assembly with a single stage of unducted rotor blades. In such a manner, the rotor assembly may be referred to herein as an “unducted rotor” or “open rotor,” or the entire gas turbine engine 100 may be referred to as an “open rotor engine.” In addition, the gas turbine engine 100 of FIG. 1 includes a third stream extending from a location downstream of a ducted mid-fan to a bypass passage over the turbomachine, as will be explained in more detail below.

For reference, the gas turbine engine 100 defines an axial direction A, a radial direction R, and a circumferential direction C. Moreover, the gas turbine engine 100 defines an axial centerline or longitudinal axis 112 that extends along the axial direction A. In general, the axial direction A extends parallel to the longitudinal axis 112, the radial direction R extends outward from and inward to the longitudinal axis 112 in a direction orthogonal to the axial direction A, and the circumferential direction extends three hundred sixty degrees (360°) around the longitudinal axis 112. The gas turbine engine 100 extends between a forward end 114 and an aft end 116, e.g., along the axial direction A.

The gas turbine engine 100 includes a turbomachine 120 and a rotor assembly, also referred to a fan section 150, positioned upstream thereof. Generally, the turbomachine 120 includes, in serial flow order, a compressor section 121, a combustion section 130, a turbine section 131, and an exhaust section 139. Particularly, as shown in FIG. 1, the turbomachine 120 includes a core cowl 122 that defines an annular core inlet 124. The core cowl 122 further encloses at least in part a low-pressure system and a high-pressure system. For example, the core cowl 122 depicted encloses and supports at least in part a booster or low-pressure (“LP”) compressor 126 for pressurizing the air that enters the turbomachine 120 through the core inlet 124. A multi-stage, axial-flow, high-pressure (“HP”) compressor 128 receives pressurized air from the LP compressor 126 and further increases the pressure of the air. The pressurized air stream flows downstream to a combustor 133 of the combustion section 130 where fuel is injected into the pressurized air stream and ignited to raise the temperature and energy level of the pressurized air.

It will be appreciated that as used herein, the terms “high/low speed” and “high/low pressure” are used with respect to the high pressure/high speed system and low pressure/low speed system interchangeably. Further, it will be appreciated that the terms “high” and “low” are used in this same context to distinguish the two systems and are not meant to imply any absolute speed and/or pressure values.

The high energy combustion products flow from the combustion section 130 downstream to a HP turbine 132. The HP turbine 132 drives the HP compressor 128 through a HP shaft 136. In this regard, the HP turbine 132 is drivingly coupled with the HP compressor 128. As will be appreciated, the HP compressor 128, the combustion section 130, and the HP turbine 132 may collectively be referred to as the “core” of the gas turbine engine 100. The high energy combustion products then flow to a LP turbine 134. The LP turbine 134 drives the LP compressor 126 and components of the fan section 150 through a LP shaft 138. In this regard, the LP turbine 134 is drivingly coupled with the LP compressor 126 and components of the fan section 150. The LP shaft 138 is coaxial with the HP shaft 136 in this example embodiment. After driving each of the HP and LP turbines 132, 134, the combustion products exit the turbomachine 120 through a turbomachine exhaust nozzle 140.

Accordingly, the turbomachine 120 defines a working gas flowpath 142 that extends between the core inlet 124 and the turbomachine exhaust nozzle 140. The working gas flowpath 142 is an annular duct positioned generally inward of the core cowl 122 along the radial direction R. The working gas flowpath 142 (e.g., the working gas flowpath through the turbomachine 120) may be referred to as a second stream.

The fan section 150 includes a fan 152, which is the primary fan in this example embodiment. For the depicted embodiment of FIG. 1, the fan 152 is an open rotor or unducted fan. As depicted, the fan 152 includes an array of fan blades 154 (only one shown in FIG. 1). The fan blades 154 are rotatable, e.g., about the longitudinal axis 112. As noted above, the fan 152 is drivingly coupled with the LP turbine 134 via the LP shaft 138. For the embodiments shown in FIG. 1, the fan 152 is coupled with the LP shaft 138 via a speed reduction gearbox 155, e.g., in an indirect-drive or geared-drive configuration.

Moreover, the array of fan blades 154 can be arranged in equal spacing around the longitudinal axis 112. Each fan blade 154 has a root and a tip and a span defined therebetween, and further defines a central blade axis 156. For this embodiment, each fan blade 154 of the fan 152 is rotatable about its respective central blade axis 156, e.g., in unison with one another. One or more actuators 158 are provided to facilitate such rotation and therefore may be used to change a pitch of the fan blades 154 about their respective central blades' axes 156.

The fan section 150 further includes a fan guide vane array 160 that includes fan guide vanes 162 (only one shown in FIG. 1) disposed around the longitudinal axis 112. For this embodiment, the fan guide vanes 162 are not rotatable about the longitudinal axis 112. Each fan guide vane 162 has a root and a tip and a span defined therebetween. The fan guide vanes 162 may be unshrouded as shown in FIG. 1 or, alternatively, may be shrouded, e.g., by an annular shroud spaced outward from the tips of the fan guide vanes 162 along the radial direction R or attached to the fan guide vanes 162.

Each fan guide vane 162 defines a central blade axis 164. For this embodiment, each fan guide vane 162 of the fan guide vane array 160 is rotatable about its respective central blade axis 164, e.g., in unison with one another. One or more actuators 166 are provided to facilitate such rotation and therefore may be used to change a pitch of the fan guide vane 162 about its respective central blade axis 164. However, in other embodiments, each fan guide vane 162 may be fixed or unable to be pitched about its central blade axis 164. The fan guide vanes 162 are mounted to a fan cowl 170. Notably, the gas turbine engine 100 defines a bypass passage 194 over the fan cowl 170 and core cowl 122.

As shown in FIG. 1, in addition to the fan 152, which is unducted, a ducted fan 184 is included aft of the fan 152, such that the gas turbine engine 100 includes both a ducted and an unducted fan which both serve to generate thrust through the movement of air without passage through at least a portion of the turbomachine 120 (e.g., without passage through the HP compressor 128 and the combustion section 130 for the embodiment depicted). The ducted fan 184 is rotatable about the same axis (e.g., the longitudinal axis 112) as the fan 152. The ducted fan 184 is, for the embodiment depicted, driven by the LP turbine 134 (e.g. coupled to the LP shaft 138). In the embodiment depicted, as noted above, the fan 152 may be referred to as the primary fan, and the ducted fan 184 may be referred to as a secondary fan. It will be appreciated that these terms “primary” and “secondary” are terms of convenience, and do not imply any particular importance, power, or the like.

The ducted fan 184 includes a plurality of fan blades (not separately labeled in FIG. 1) arranged in a single stage, such that the ducted fan 184 may be referred to as a single stage fan. The fan blades of the ducted fan 184 can be arranged in equal spacing around the longitudinal axis 112. Each blade of the ducted fan 184 has a root and a tip and a span defined therebetween.

The fan cowl 170 annularly encases at least a portion of the core cowl 122 and is generally positioned outward of at least a portion of the core cowl 122 along the radial direction R. Particularly, a downstream section of the fan cowl 170 extends over a forward portion of the core cowl 122 to define a fan duct flowpath, or simply a fan duct 172. According to this embodiment, the fan duct flowpath or fan duct 172 may be understood as forming at least a portion of the third stream of the gas turbine engine 100.

Incoming air may enter through the fan duct 172 through a fan duct inlet 176 and may exit through a fan exhaust nozzle 178 to produce propulsive thrust. The fan duct 172 is an annular duct positioned generally outward of the working gas flowpath 142 along the radial direction R. The fan cowl 170 and the core cowl 122 are connected together and supported by a plurality of substantially radially-extending, circumferentially-spaced stationary struts 174 (only one shown in FIG. 1). The stationary struts 174 may each be aerodynamically contoured to direct air flowing thereby. Other struts in addition to the stationary struts 174 may be used to connect and support the fan cowl 170 and/or core cowl 122. In many embodiments, the fan duct 172 and the working gas flowpath 142 may at least partially co-extend (generally axially) on opposite sides (e.g., opposite radial sides) of the core cowl 122. For example, the fan duct 172 and the working gas flowpath 142 may each extend directly from a leading edge 144 of the core cowl 122 and may partially co-extend generally axially on opposite radial sides of the core cowl 122.

The gas turbine engine 100 also defines or includes an inlet duct 180. The inlet duct 180 extends between an engine inlet 182 and the core inlet 124/fan duct inlet 176. The engine inlet 182 is defined generally at the forward end of the fan cowl 170 and is positioned between the fan 152 and the fan guide vane array 160 along the axial direction A. The inlet duct 180 is an annular duct that is positioned inward of the fan cowl 170 along the radial direction R. Air flowing downstream along the inlet duct 180 is split, not necessarily evenly, into the working gas flowpath 142 and the fan duct 172 by the leading edge 144 of the core cowl 122. The inlet duct 180 is wider than the working gas flowpath 142 along the radial direction R. The inlet duct 180 is also wider than the fan duct 172 along the radial direction R. The ducted fan 184 is positioned at least partially in the inlet duct 180.

Notably, for the embodiment depicted, the gas turbine engine 100 includes one or more features to increase an efficiency of a third stream thrust, Fn_{3S} (e.g., a thrust generated by an airflow through the fan duct 172 exiting through the fan exhaust nozzle 178, generated at least in part by the ducted fan 184). In particular, the gas turbine engine 100 further includes an array of inlet guide vanes 186 positioned in the inlet duct 180 upstream of the ducted fan 184 and downstream of the engine inlet 182. The array of inlet guide vanes 186 are arranged around the longitudinal axis 112. For this embodiment, the inlet guide vanes 186 are not rotatable about the longitudinal axis 112. Each inlet guide vane 186 defines a central blade axis (not labeled for clarity), and is rotatable about its respective central blade axis, e.g., in unison with one another. In such a manner, the inlet guide vanes 186 may be considered a variable geometry component. One or more actuators 188 are provided to facilitate such rotation and therefore may be used to change a pitch of the inlet guide vanes 186 about their respective central blade axes. However, in other embodiments, each inlet guide vane 186 may be fixed or unable to be pitched about its central blade axis.

Further, located downstream of the ducted fan 184 and upstream of the fan duct inlet 176, the gas turbine engine 100 includes an array of outlet guide vanes 190. As with the array of inlet guide vanes 186, the array of outlet guide vanes 190 are not rotatable about the longitudinal axis 112. However, for the embodiment depicted, unlike the array of inlet guide vanes 186, the array of outlet guide vanes 190 are configured as fixed-pitch outlet guide vanes.

Further, it will be appreciated that for the embodiment depicted, the fan exhaust nozzle 178 of the fan duct 172 is further configured as a variable geometry exhaust nozzle. In such a manner, the gas turbine engine 100 includes one or more actuators 192 for modulating the variable geometry exhaust nozzle. For example, the variable geometry exhaust nozzle may be configured to vary a total cross-sectional area (e.g., an area of the nozzle in a plane perpendicular to the longitudinal axis 112) to modulate an amount of thrust generated based on one or more engine operating conditions (e.g., temperature, pressure, mass flowrate, etc. of an airflow through the fan duct 172). A fixed geometry exhaust nozzle may also be adopted.

The combination of the array of inlet guide vanes 186 located upstream of the ducted fan 184, the array of outlet guide vanes 190 located downstream of the ducted fan 184, and the fan exhaust nozzle 178 may result in a more efficient generation of third stream thrust, Fn_{3S}, during one or more engine operating conditions. Further, by introducing a variability in the geometry of the inlet guide vanes 186 and the fan exhaust nozzle 178, the gas turbine engine 100 may be capable of generating more efficient third stream thrust, Fn_{3S}, across a relatively wide array of engine operating conditions, including takeoff and climb as well as cruise.

Moreover, referring still to FIG. 1, in exemplary embodiments, air passing through the fan duct 172 may be relatively cooler (e.g., lower temperature) than one or more fluids utilized in the turbomachine 120. In this way, one or more heat exchangers 196 may be positioned in thermal communication with the fan duct 172. For example, one or more heat exchangers 196 may be disposed within the fan duct 172 and utilized to cool one or more fluids from the core engine with the air passing through the fan duct 172, as a resource for removing heat from a fluid, e.g., compressor bleed air, oil or fuel. In exemplary embodiments, the one or more heat exchangers 196 may include an air-cooled oil cooler. It should also be understood that the one or more heat exchangers 196 may be located elsewhere in the gas turbine engine 100 as a resource for transferring thermal energy between fluids, e.g., compressor bleed air, oil or fuel such as, by way of non-limiting example, a fuel-cooled oil cooler.

Although not depicted in the example of FIG. 1, the heat exchanger 196 may be an annular heat exchanger extending substantially 360 degrees in the fan duct 172 (e.g., at least 300 degrees, such as at least 330 degrees, etc.). In an annular configuration, the heat exchanger 196 may effectively utilize the air passing through the fan duct 172 to cool one or more systems of the gas turbine engine 100 (e.g., a cooled cooling air system (described below), lubrication oil systems, compressor bleed air, electrical components, etc.). The heat exchanger 196 uses the air passing through the fan duct 172 as a heat sink and correspondingly increases the temperature of the air downstream of the heat exchanger 196 and exiting the fan exhaust nozzle 178.

As will be appreciated, the gas turbine engine 100 defines a total sea level static thrust output Fn_{Total}, corrected to standard day conditions, which is generally equal to a maximum total engine thrust. It will be appreciated that “sea level static thrust corrected to standard day conditions” refers to an amount of thrust an engine is capable of producing while at rest relative to the earth and the surrounding air during standard day operating conditions.

The total sea level static thrust output Fn_{Total} may generally be equal to a sum of: a fan stream thrust Fn_{Fan} (i.e., an amount of thrust generated by the fan 152 through the bypass passage 194), the third stream thrust Fn_{3S} (i.e., an amount of thrust generated through the fan duct 172), and a turbomachine thrust Fn_{TM} (i.e., an amount of thrust generated by an airflow through the turbomachine exhaust nozzle 140), each during the static, sea level, standard day conditions. The gas turbine engine 100 may define a total sea level static thrust output Fn_{Total} greater than or equal to 15,000 pounds. For example, it will be appreciated that the gas turbine engine 100 may be configured to generate at least 25,000 pounds and less than 80,000 pounds, such as between 25,000 and 50,000 pounds, such as between 35,000 and 45,000 pounds of thrust during a takeoff operating power, corrected to standard day sea level conditions.

In exemplary embodiments, the gas turbine engine 100 includes one or more additively manufactured metal components 198. In FIG. 1, at least one of the one or more additively manufactured metal components 198 includes the heat exchanger 196. In exemplary embodiments, at least one of the one or more additively manufactured metal components 198 includes the heat exchanger 196 configured as an air-cooled oil cooler.

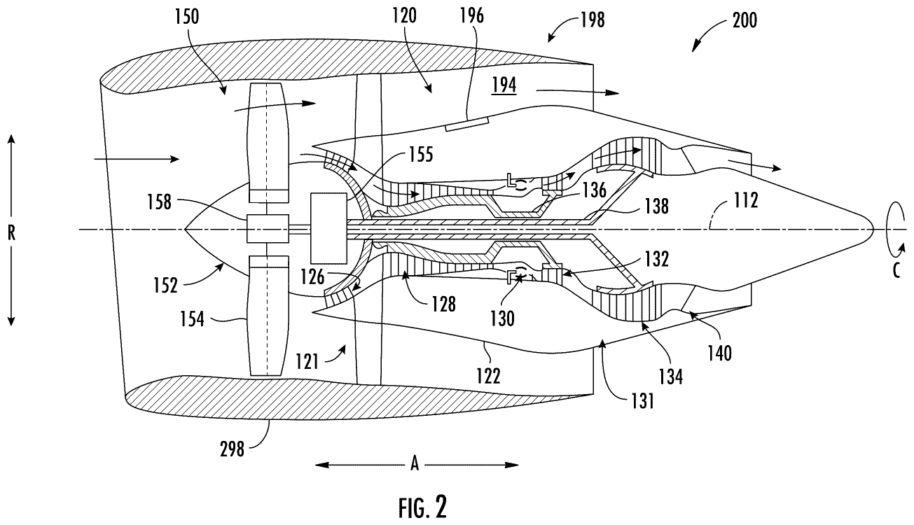

FIG. 2 provides a schematic view of a gas turbine engine 200 in accordance with another exemplary embodiment of the present disclosure. The exemplary embodiment of FIG. 2 may be configured in substantially the same manner as the exemplary gas turbine engine 100 described above with respect to FIG. 1, and the same or similar reference numerals may refer to the same or similar parts. However, as will be appreciated, for the embodiment shown, an outer housing or nacelle 298 circumferentially surrounds at least in part the fan section 150 and the turbomachine 120. The nacelle 298 defines the bypass passage 194 between the nacelle 298 and the turbomachine 120. Briefly, it will be appreciated that the exemplary gas turbine engine 200 of FIG. 2 is configured as a two-stream engine, i.e., an engine without a third stream (e.g., without the fan stream through the fan duct 172 in the exemplary gas turbine engine 100 of FIG. 1). More particularly, for the embodiment of FIG. 2, the gas turbine engine 200 is a high-bypass turbofan jet engine, sometimes also referred to as a “turbofan engine.” In exemplary embodiments, the gas turbine engine 200 also includes one or more additively manufactured metal components 198 such as, by way of non-limiting example, the heat exchanger 196.

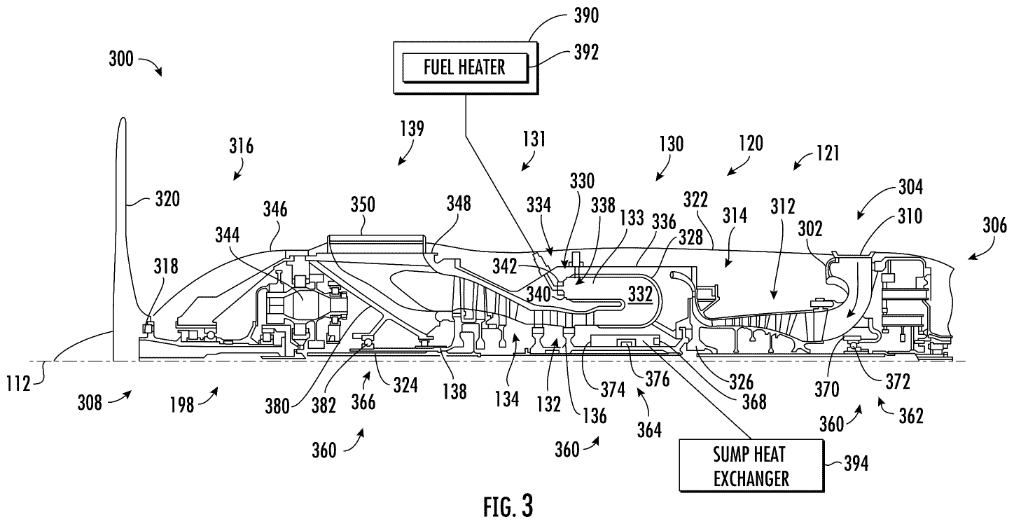

FIG. 3 is a schematic cross-sectional view of a gas turbine engine 300 in accordance with an exemplary embodiment of the present disclosure. The exemplary embodiment of FIG. 3 may be configured in substantially the same manner as the exemplary gas turbine engine 100 described above with respect to FIG. 1 or the gas turbine engine 200 described above with respect to FIG. 2, and the same or similar reference numerals may refer to the same or similar parts. More particularly, for the embodiment of FIG. 3, the gas turbine engine 300 is a reverse flow turboprop engine. In exemplary embodiments, the gas turbine engine 200 also includes one or more additively manufactured metal components 198.

As shown in FIG. 3, the gas turbine engine 300 generally includes an inlet frame 302 defining an inlet 304. Air is taken in at the inlet 304 and flows in a forward direction from an aft end 306 of the gas turbine engine 300 toward a forward end 308 of the gas turbine engine 300. The air is taken in at the inlet 304 through one or more inlet screens 310. In exemplary embodiments, at least one of the one or more additively manufactured metal components 198 may include the inlet frame 302 and/or the inlet screens 310. In other words, the inlet frame 302 and/or the inlet screens 310 may be formed using an additive-manufacturing process, such as a three-dimensional (3-D) printing process. The use of such a process enables the inlet frame 302 and/or the inlet screens 310 to be formed integrally, as a single monolithic component. In particular, the additive manufacturing process may allow the inlet frame 302, the inlet screens 310, or a combination of the inlet frame 302 with the inlet screens 310, to be integrally formed and include a variety of features not possible when using prior manufacturing methods. For example, the additive manufacture of the inlet frame 302 and/or inlet screens 310 enables the manufacture of the inlet frame 302 and/or inlet screens 310 having various features, configurations, thicknesses, materials, densities, fluid passageways, and mounting structures not possible using prior manufacturing methods. In exemplary embodiments, the inlet frame 302 and/or inlet screens 310 are additively manufactured metal components.

The gas turbine engine 300 also includes, in serial flow relationship, the compressor section 121 defined by a compressor 312 and a centrifugal compressor 314, the combustion section 130 including the combustor 133, the turbine section 131 including the HP turbine 132 and the LP turbine 134, the exhaust section 139, and a propeller section 316. The propeller section 316 includes a propeller hub 318 having a plurality of propeller blades 320 disposed radially about the longitudinal axis 112. An engine casing 322 can form an annular casing for each of the sections.

The HP shaft 136 disposed coaxially about the longitudinal axis 112 drivingly connects the HP turbine 132 to the compressor 312 and the centrifugal compressor 314. The LP shaft 138, which is disposed coaxially about the longitudinal axis 112 in line with and separate from the HP shaft 136, drivingly connects the LP turbine 134 to the propeller hub 318. The HP and LP shafts 136, 138 are rotatable about the longitudinal axis 112 and couple to a plurality of rotatable elements, which can collectively define a rotor 324.

The compressor 312 includes at least one compressor stage in which a set of compressor blades rotate relative to a corresponding set of static compressor vanes to compress or pressurize the stream of fluid passing through the stage. The centrifugal compressor 314 can include an impeller 326 having a set of impeller blades. In a single compressor stage, multiple compressor blades can be provided in a ring and can extend radially outwardly relative to the longitudinal axis 112, from a blade platform to a blade tip, while the corresponding static compressor vanes are positioned upstream of and adjacent to the rotating blades. The HP turbine 132 and the LP turbine 134 may include a plurality of turbine stages in which a set of turbine blades are rotated relative to a corresponding set of static turbine vanes to extract energy from the stream of fluid passing through the stage. In a single turbine stage, multiple turbine blades can be provided in a ring and can extend radially outwardly relative to the longitudinal axis 112, from a blade platform to a blade tip, while the corresponding static turbine vanes are positioned upstream of and adjacent to the rotating blades.

In operation, the airflow entering the inlet 304 is channeled into the compressor 312, which then supplies pressurized air to the centrifugal compressor 314, which further pressurizes the air. The pressurized air from the centrifugal compressor 314 mixes with fuel in the combustor 133 where the fuel combusts, generating combustion gases. The combustor 133 can include an annular combustor liner 328 and a dome assembly 330 defining a combustor chamber 332, and a plurality of fuel nozzles 334 fluidly coupled to the combustor chamber 332. In exemplary embodiments, at least one of the one or more additively manufactured metal components 198 may include the combustor liner 328. In other words, the combustor liner 328 may be formed using an additive manufacturing process, such as a 3-D printing process. The use of such a process enables the combustor liner 328 to be formed integrally, as a single monolithic component. In particular, the additive manufacturing process may allow the combustor liner 328 to be integrally formed and include a variety of features not possible when using prior manufacturing methods. For example, the additive manufacture of the combustor liner 328 enables the combustor liner 328 to have various features, configurations, thicknesses, materials, densities, fluid passageways, and mounting structures not possible using prior manufacturing methods. In exemplary embodiments, the combustor liner 328 is an additively manufactured metal component.

The combustor 133 is disposed within a combustor casing 336. The plurality of fuel nozzles 334 are coupled to and disposed within the dome assembly 330 at a dome inlet 338 comprising a flare cone 340. The plurality of fuel nozzles 334 are in fluid communication with the combustor chamber 332 and are adapted to receive and provide a flow of fuel 118 to the combustor chamber 332. A swirler 342 can be provided at the dome inlet 338 to swirl incoming air in proximity to the fuel exiting the fuel nozzle 334 and provide a homogeneous mixture of air and fuel entering the combustor 133. In exemplary embodiments, at least one of the one or more additively manufactured metal components 198 may include the fuel nozzle 334 and/or the swirler 342. In exemplary embodiments, the fuel nozzle 334, the swirler 342, or both the fuel nozzle 334 and the swirler 342 as an integral component, may be formed using an additive-manufacturing process, such as a 3-D printing process. The use of such a process enables the fuel nozzle 334 and/or the swirler 342, separately or together, to be formed integrally, as a single monolithic component. In particular, the additive manufacturing process may allow the fuel nozzle 334 and/or the swirler 342 to be integrally formed and include a variety of features not possible when using prior manufacturing methods. For example, the additive manufacture of the fuel nozzle 334 and/or the swirler 342 enables the fuel nozzle 334 and/or the swirler 342 to have various features, configurations, thicknesses, materials, densities, fluid passageways, and mounting structures not possible using prior manufacturing methods. In exemplary embodiments, the fuel nozzle 334 and/or the swirler 342 are additively manufactured metal components.

The HP turbine 132 extracts some work from these gases, which drives the compressor 312 and the centrifugal compressor 314. The HP turbine 132 discharges the combustion gases into the LP turbine 134, which extracts additional work to drive the propeller hub 318, and the exhaust gas is ultimately discharged from the gas turbine engine 300 via the exhaust section 139. The exhaust section 139 may include an exhaust case 348 supporting one or more radial exhaust ducts 350 through which the exhaust gas is ultimately discharged from the gas turbine engine 300. In exemplary embodiments, at least one of the one or more additively manufactured metal components 198 may include the exhaust case 348. In exemplary embodiments, the exhaust case 348 may be formed using an additive-manufacturing process, such as a 3-D printing process. The use of such a process enables the exhaust case 348 to be formed integrally, as a single monolithic component. In particular, the additive manufacturing process may allow the exhaust case 348 to be integrally formed and include a variety of features not possible when using prior manufacturing methods. For example, the additive manufacture of the exhaust case 348 enables the exhaust case 348 to have various features, configurations, thicknesses, materials, densities, fluid passageways, and mounting structures not possible using prior manufacturing methods. In exemplary embodiments, the exhaust case 348 is an additively manufactured metal component.

The LP turbine 134 drives the LP shaft 138 to rotate the propeller hub 318 and in turn the propeller blades 320. A gear assembly 344 disposed within a gearbox housing 346 is provided between the LP shaft 138 and the propeller hub 318. The gear assembly 344 may include a gear train assembly such as, by way of non-limiting example, a planetary configuration or a star configuration. The gearbox housing 346 may contain a lubricant for lubricating the gear assembly 344. The gearbox housing 346 may be fluidly could to a lubrication system for supplying a lubricant to the gear assembly 344. In exemplary embodiments, at least one of the one or more additively manufactured metal components 198 may include the gearbox housing 346. In exemplary embodiments, the gearbox housing 346 may be formed using an additive-manufacturing process, such as a 3-D printing process. The use of such a process enables the gearbox housing 346 to be formed integrally, as a single monolithic component. In particular, the additive manufacturing process may allow the gearbox housing 346 to be integrally formed and include a variety of features not possible when using prior manufacturing methods. For example, the additive manufacture of the gearbox housing 346 enables the gearbox housing 346 to have various features, configurations, thicknesses, materials, densities, fluid passageways, and mounting structures not possible using prior manufacturing methods. In exemplary embodiments, the gearbox housing 346 is an additively manufactured metal component.

The gas turbine engine 300 may also include one or more sump assemblies 360 each supporting one or more bearing assemblies. In the illustrated embodiment, the one or more sump assemblies 360 include an A-sump 362, a B-sump 364, and a C-sump 366. The A-sump 362 may include a sump housing 370 housing one or more bearings 372 that rotatably support the aft end of the LP shaft 138. Furthermore, the B-sump 364 may include a sump housing 374 housing one or more bearings 376 that rotatably support the HP shaft 136. Moreover, the C-sump 366 may include a sump housing 380 housing one or more bearings 382 that rotatably support the forward end of the LP shaft 138. Each of the sump housings 370, 374, 380 may be fluidly coupled to a lubrication system for supplying a lubricant to the respective bearings 372, 376, 382. In exemplary embodiments, at least one of the one or more additively manufactured metal components 198 may include one or more of the sump housings 370, 374, or 380. In exemplary embodiments, one or more of the sump housings 370, 374, 380 may be formed using an additive-manufacturing process, such as a 3-D printing process. The use of such a process enables the sump housings 370, 374, 380 to be formed integrally, as a single monolithic component. In particular, the additive manufacturing process may allow the respective sump housings 370, 374, 380 to be integrally formed and include a variety of features not possible when using prior manufacturing methods. For example, the additive manufacture of the respective sump housings 370, 374, 380 enables the respective sump housings 370, 374, 380 to have various features, configurations, thicknesses, materials, densities, fluid passageways, and mounting structures not possible using prior manufacturing methods. In exemplary embodiments, one or more of the sump housings 370, 374, 380 are additively manufactured metal components. In exemplary embodiments, one or more of the sump housings 370, 374, 380 may be additively manufactured to include integrally formed de-swirlers 368.

As described above, air is mixed with fuel in the combustion section 130 to produce combustion gases. As shown schematically in FIG. 3, the gas turbine engine 300 may include a fuel delivery system 390 for providing fuel to the combustion section 130 of the gas turbine engine 300. The fuel delivery system 390 may include a fuel tank and one or more fuel delivery lines, which may form a fuel flowpath from a fuel source (e.g., a fuel tank) to the combustion section 130. In other embodiments, however, the fuel delivery system 390 may be considered part of a vehicle, such as an aircraft in which the gas turbine engine 300 is installed, rather than as part of the gas turbine engine 300. In exemplary embodiments, the fuel delivery system 390 may include a fuel heater 392. The fuel heater 392 may include a fuel circulation loop and/or heat exchanger configured to transfer thermal energy to the fuel to heat the fuel before delivering the fuel to the combustor 133. In exemplary embodiments, at least one of the one or more additively manufactured metal components 198 may include the fuel heater 392. In exemplary embodiments, the fuel heater 392 may be an oil-to-fuel heat exchanger configured to heat the fuel by using oil, such as, by way of non-limiting example, transmission gear oil. In exemplary embodiments, the fuel heater 392 may be formed using an additive-manufacturing process, such as a 3-D printing process. The use of such a process enables the fuel heater 392 to be formed integrally, as a single monolithic component. In particular, the additive manufacturing process may allow the fuel heater 392 to be integrally formed and include a variety of features not possible when using prior manufacturing methods. For example, the additive manufacture of the fuel heater 392 enables the fuel heater 392 to have various features, configurations, thicknesses, materials, densities, fluid passageways, and mounting structures not possible using prior manufacturing methods. In exemplary embodiments, the fuel heater 392 is an additively manufactured metal component.

In exemplary embodiments, the gas turbine engine 300 may also include one or more sump heat exchangers 394 depicted schematically in FIG. 3. In FIG. 3, the sump heat exchanger 394 is depicted as a B-sump heat exchanger to cool the B-sump 364 by using at least a portion of air extracted from the compressor section 121 to cool the B-sump 364. However, it should be understood that one or more sump heat exchangers 394 may also be provided and used in connection with other sumps such as, by way of non-limiting example, the A-sump 362 or the C-sump 366. In exemplary embodiments, the sump heat exchanger 394 may be formed using an additive-manufacturing process, such as a 3-D printing process. The use of such a process enables the sump heat exchanger 394 to be formed integrally, as a single monolithic component. In particular, the additive manufacturing process may allow the sump heat exchanger 394 to be integrally formed and include a variety of features not possible when using prior manufacturing methods. For example, the additive manufacture of the sump heat exchanger 394 enables the sump heat exchanger 394 to have various features, configurations, thicknesses, materials, densities, fluid passageways, and mounting structures not possible using prior manufacturing methods. In exemplary embodiments, the sump heat exchanger 394 is an additively manufactured metal component.

It should be understood that various components depicted and/or described with a particular type of gas turbine engine in the present disclosure may also be included in another type of gas turbine engine as depicted and described herein. In other words, one or more components depicted and/or described in connection with the gas turbine engine 100 (FIG. 1) may be used with or incorporated into the gas turbine engine 200 (FIG. 2) or the gas turbine engine 300 (FIG. 3). Similarly, one or more components depicted and/or described in connection with the gas turbine engine 200 (FIG. 2) may be used with or incorporated into the gas turbine engine 100 (FIG. 1) or the gas turbine engine 300 (FIG. 3), and one or more components depicted and/or described in connection with the gas turbine engine 300 (FIG. 3) may be used with or incorporated into the gas turbine engine 100 (FIG. 1) or the gas turbine engine 200 (FIG. 2). Thus, the heat exchanger 196 of the gas turbine engine 100 (FIG. 1), such as an air-cooled oil cooler, may be used in or incorporated into the gas turbine engine 200 (FIG. 2) or 300 (FIG. 3). Similarly, the fuel nozzles 334 and the swirler 342 of the gas turbine engine 300 (FIG. 3) may be used in or incorporated into the gas turbine engine 100 (FIG. 1) or 200 (FIG. 2). The same applies to other components described above in connection with the gas turbine engines 100, 200, 300.

In exemplary embodiments, a total mass of the additively manufactured metal components 198 in at least one of the gas turbine engines 100, 200, 300 is at least 1% or greater of a total dry mass of the respective gas turbine engine 100, 200, 300. In exemplary embodiments, a total mass of the additively manufactured metal components 198 in at least one of the gas turbine engines 100, 200, 300 is in a range from 1% to 50% of a total dry mass of the respective gas turbine engine 100, 200, 300. In exemplary embodiments, a total mass of the additively manufactured metal components 198 in at least one of the gas turbine engines 100, 200, 300 is in a range from 1.5% to 25% of a total dry mass of the respective gas turbine engine 100, 200, 300. In exemplary embodiments, a total mass of the additively manufactured metal components 198 in at least one of the gas turbine engines 100, 200, 300 is in a range from 2% to 20% of a total dry mass of the respective gas turbine engine 100, 200, 300. In exemplary embodiments, a total mass of the additively manufactured metal components 198 in at least one of the gas turbine engines 100, 200, 300 is at least 3% or greater of a total dry mass of the respective gas turbine engine 100, 200, 300. In exemplary embodiments, at least one of the gas turbine engines 100, 200, 300 includes at least three different types of additively manufactured metal components 198. As used herein a “different type” of an additively manufactured metal component 198 shall mean a component designed or configured for a purpose or function different than another type of component. In other words, a fuel heater may be considered a “different type” of component with respect to a fuel nozzle, or a sump housing may be considered a “different type” of a component compared to an exhaust frame. In exemplary embodiments, at least one of the gas turbine engines 100, 200, 300 includes at least four different types of additively manufactured metal components 198. In exemplary embodiments, at least one of the gas turbine engines 100, 200, 300 includes at least five different types of additively manufactured metal components 198. In exemplary embodiments, at least one of the gas turbine engines 100, 200, 300 includes at least seven different types of additively manufactured metal components 198.

In exemplary embodiments, at least one of the gas turbine engines 100, 200, 300 includes one or more of the fuel heater 392, the sump housing 370, the sump housing 374, the sump housing 380, the heat exchanger 196, the swirler 342, the fuel nozzle 334, the gearbox housing 346, the exhaust case 348, the combustor liner 328, the inlet frame 302, or the inlet screen 310 that are additively manufactured metal components 198. In exemplary embodiments, at least one of the gas turbine engines 100, 200, 300 includes the fuel heater 392 as an additively manufactured metal component 198. In exemplary embodiments, at least one of the gas turbine engines 100, 200, 300 includes the sump housing 370 as an additively manufactured metal component 198. In exemplary embodiments, at least one of the gas turbine engines 100, 200, 300 includes the sump housing 374 as an additively manufactured metal component 198. In exemplary embodiments, at least one of the gas turbine engines 100, 200, 300 includes the sump housing 380 as an additively manufactured metal component 198. In exemplary embodiments, at least one of the gas turbine engines 100, 200, 300 includes the heat exchanger 196 as an additively manufactured metal component 198 in the form of an air-cooled oil cooler. In exemplary embodiments, at least one of the gas turbine engines 100, 200, 300 includes the swirler 342 as an additively manufactured metal component 198. In exemplary embodiments, at least one of the gas turbine engines 100, 200, 300 includes the fuel nozzle 334 as an additively manufactured metal component 198. In exemplary embodiments, at least one of the gas turbine engines 100, 200, 300 includes the fuel nozzle 334 together with the swirler 342 as an additively manufactured metal component 198. In exemplary embodiments, at least one of the gas turbine engines 100, 200, 300 includes the gearbox housing 346 as an additively manufactured metal component 198. In exemplary embodiments, at least one of the gas turbine engines 100, 200, 300 includes the exhaust case 348 as an additively manufactured metal component 198. In exemplary embodiments, at least one of the gas turbine engines 100, 200, 300 includes the combustor liner 328 as an additively manufactured metal component 1968. In exemplary embodiments, at least one of the gas turbine engines 100, 200, 300 includes the inlet frame 302 as an additively manufactured metal component 198. In exemplary embodiments, at least one of the gas turbine engines 100, 200, 300 includes the inlet screen 310 as an additively manufactured metal component 198. In exemplary embodiments, at least one of the gas turbine engines 100, 200, 300 includes the inlet frame 302 together with one or more inlet screens 310 as an additively manufactured metal component 198.

In exemplary embodiments, at least one of the gas turbine engines 100, 200, 300 includes at least one sump housing 370, 374, or 380 being an additively manufactured metal component 198 having a mass in the range from 1% to 5% of the total dry mass of the respective gas turbine engine 100, 200, or 300. In exemplary embodiments, at least one of the gas turbine engines 100, 200, 300 includes at least one sump housing 370, 374, or 380 being an additively manufactured metal component 198 having a mass in the range from 1.5% to 4% of the total dry mass of the respective gas turbine engine 100, 200, or 300. In exemplary embodiments, at least one of the gas turbine engines 100, 200, 300 includes the fuel heater 392 being an additively manufactured metal component 198 having a mass in the range from 0.25% to 0.7% of the total dry mass of the respective gas turbine engine 100, 200, or 300. In exemplary embodiments, at least one of the gas turbine engines 100, 200, 300 includes the fuel heater 392 being an additively manufactured metal component 198 having a mass in the range from 0.3% to 0.6% of the total dry mass of the respective gas turbine engine 100, 200, or 300. In exemplary embodiments, at least one of the gas turbine engines 100, 200, 300 includes the heat exchanger 196 being an additively manufactured metal component 198 having a mass in the range from 0.25 to 0.7% of the total dry mass of the respective gas turbine engine 100, 200, or 300. In exemplary embodiments, at least one of the gas turbine engines 100, 200, 300 includes the fuel heater 392 being an additively manufactured metal component 198 having a mass in the range from 0.3% to 0.6% of the total dry mass of the respective gas turbine engine 100, 200, or 300. In exemplary embodiments, at least one of the gas turbine engines 100, 200, 300 includes the fuel nozzle 334 being an additively manufactured metal component 198 having a mass in the range from 0.01% to 0.017% of the total dry mass of the respective gas turbine engine 100, 200, or 300. In exemplary embodiments, at least one of the gas turbine engines 100, 200, 300 includes the fuel nozzle 334 being an additively manufactured metal component 198 having a mass in the range from 0.012% to 0.015% of the total dry mass of the respective gas turbine engine 100, 200, or 300. In exemplary embodiments, at least one of the gas turbine engines 100, 200, 300 includes the sump housing 374 for the B-sump 364 being an additively manufactured metal component 198 having a mass in the range from 1% to 5% of the total dry mass of the respective gas turbine engine 100, 200, or 300. In exemplary embodiments, at least one of the gas turbine engines 100, 200, 300 includes the sump housing 374 for the B-sump 364 being an additively manufactured metal component 198 having a mass in the range from 1.5% to 4% of the total dry mass of the respective gas turbine engine 100, 200, or 300.

Thus, in exemplary embodiments, the present inventors have found that additively manufacturing certain components of the gas turbine engine in the ranges as defined herein with respect to the total dry mass of the gas turbine engine reduces an overall length of the gas turbine engine and reduces the dry mass of the gas turbine engine and, correspondingly, improving fuel efficiency. The present inventors have found that additively manufacturing certain components of the gas turbine engine in the ranges as defined herein with respect to the total dry mass of the gas turbine engine reduces the complexity of assembling the gas turbine engine by reducing a quantity of parts and correspondingly reducing a quantity of assembly joints. In an exemplary embodiment, the present inventors have found that integrating a de-swirler into a sump housing enabled a reduction in an overall length of the gas turbine engine.

This written description uses examples to disclose the present disclosure, including the best mode, and also to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

Further aspects are provided by the subject matter of the following clauses:

A gas turbine engine comprising: a turbomachine comprising a compressor section, a combustion section, and a turbine section arranged in serial flow order, the compressor section having a compressor, the turbine section having one or more turbines; and wherein the turbomachine comprise one or more additively manufactured metal components, and wherein a total mass of the additively manufactured metal components is in a range from 1% to 50% of a total dry mass of the gas turbine engine.

The gas turbine engine of the previous clause, wherein the gas turbine engine comprises a turboprop engine of 300-8,000 Horsepower.

The gas turbine engine of any previous clause, wherein the gas turbine engine comprises a ducted turbofan engine configured to provide a range from 3,000 to 125,000 pounds thrust.

The gas turbine engine of any previous clause, wherein the gas turbine engine comprises an open rotor engine configured to provide a range from 5,000 to 60,000 pounds thrust.

The gas turbine engine of any previous clause, wherein the gas turbine engine comprises a design life of greater than at least one of 500 hours or 500 flight cycles before overhaul.

The gas turbine engine of any previous clause, further comprising one or more sump housings, wherein at least one sump housing of the one or more sump housings comprises at least one additively manufactured metal component of the one or more additively manufactured metal components, and wherein the at least one sump housing has a mass within a range of 1% to 5% of the total dry mass of the gas turbine engine.

The gas turbine engine of any previous clause, wherein the one or more additively manufactured metal components comprises at least one of a fuel heater, a sump housing, a heat exchanger, a swirler, a fuel nozzle, a gearbox housing, an exhaust case, a combustor liner, an inlet frame, or an inlet screen.

The gas turbine engine of any previous clause, wherein the one or more additively manufactured metal components comprises at least three different types of additively manufactured metal components.

A gas turbine engine, comprising: a turbomachine comprising a compressor section, a combustion section, and a turbine section arranged in serial flow order, the compressor section having a compressor, the turbine section having one or more turbines; and wherein the turbomachine comprise one or more additively manufactured metal components, and wherein a total mass of the additively manufactured metal components is at least 1% or greater of a total dry mass of the gas turbine engine.

The gas turbine engine of any previous clause, further comprising one or more sump housings, wherein at least one sump housing of the one or more sump housings comprises at least one additively manufactured metal component of the one or more additively manufactured metal components, and wherein the at least one sump housing has a mass within a range of 1% to 5% of the total dry mass of the gas turbine engine.

The gas turbine engine of any previous clause, wherein the total mass of the additively manufactured metal components is at least 3% or greater of the total dry mass of the gas turbine engine.

The gas turbine engine of any previous clause, wherein the one or more additively manufactured metal components comprises at least one of a fuel heater, a sump housing, a heat exchanger, a swirler, a fuel nozzle, a gearbox housing, an exhaust case, a combustor liner, an inlet frame, or an inlet screen.

The gas turbine engine of any previous clause, wherein the one or more additively manufactured metal components comprises at least one sump housing having an integral de-swirler.

The gas turbine engine of any previous clause, wherein the one or more additively manufactured metal components comprises at least one inlet frame having an integral inlet screen.

The gas turbine engine of any previous clause, wherein the one or more additively manufactured metal components comprises at least one sump heat exchanger.

A gas turbine engine, comprising: a turbomachine comprising a compressor section, a combustion section, and a turbine section arranged in serial flow order, the compressor section having a compressor, the turbine section having one or more turbines, the turbomachine further comprising at least one sump housing; and wherein the turbomachine comprise one or more additively manufactured metal components, and wherein the one or more additively manufactured metal components includes the at least one sump housing, and wherein a total mass of the at least one sump housing is in a range from 1% to 5% of a total dry mass of the gas turbine engine.

The gas turbine engine of any previous clause, wherein the at least one sump housing comprises at least one integral de-swirler.

The gas turbine engine of any previous clause, wherein the one or more additively manufactured metal components includes at least one of a fuel heater, a heat exchanger, a swirler, a fuel nozzle, a gearbox housing, an exhaust case, a combustor liner, an inlet frame, or an inlet screen.

The gas turbine engine of any previous clause, wherein a total mass of the one or more additively manufactured metal components is in a range from 1.5% to 25% of the total dry mass of the gas turbine engine.

The gas turbine engine of any previous clause, wherein the one or more additively manufactured metal components comprises at least five different types of additively manufactured metal components.

The gas turbine engine of any previous clause, wherein the one or more additively manufactured metal components comprises at least one sump housing having a mass in the range from 1.5% to 4% of the total dry mass of the gas turbine engine.

The gas turbine engine of any previous clause, wherein the one or more additively manufactured metal components comprises a fuel heater having a mass in the range from 0.25% to 0.7% of the total dry mass of the gas turbine engine.

The gas turbine engine of any previous clause, wherein the one or more additively manufactured metal components comprises a fuel heater having a mass in the range from 0.3% to 0.6% of the total dry mass of the gas turbine engine.

The gas turbine engine of any previous clause, wherein the one or more additively manufactured metal components comprises a heat exchanger having a mass in the range from 0.25 to 0.7% of the total dry mass of the gas turbine engine.

The gas turbine engine of any previous clause, wherein the one or more additively manufactured metal components comprises a fuel heater having a mass in the range from 0.3% to 0.6% of the total dry mass of the gas turbine engine.

The gas turbine engine of any previous clause, wherein the one or more additively manufactured metal components comprises a fuel nozzle having a mass in the range from 0.01% to 0.017% of the total dry mass of the gas turbine engine.

The gas turbine engine of any previous clause, wherein the one or more additively manufactured metal components comprises a fuel nozzle having a mass in the range from 0.012% to 0.015% of the total dry mass of the gas turbine engine.

The gas turbine engine of any previous clause, wherein the one or more additively manufactured metal components comprises a sump housing for a B-sump having a mass in the range from 1% to 5% of the total dry mass of the gas turbine engine.

The gas turbine engine of any previous clause, wherein the one or more additively manufactured metal components comprises a sump housing for a B-sump having a mass in the range from 1.5% to 4% of the total dry mass of the gas turbine engine.

The gas turbine engine of any previous clause, wherein the total mass of the one or more additively manufactured metal components is in a range from 2% to 20% of the total dry mass of the gas turbine engine.

The gas turbine engine of any previous clause, wherein the total mass of the one or more additively manufactured metal components is at least 3% or greater of the total dry mass of the respective gas turbine engine.

1. A gas turbine engine comprising:
a turbomachine comprising a compressor section, a combustion section, and a turbine section arranged in serial flow order, the compressor section having a compressor, the turbine section having one or more turbines; and
wherein the turbomachine comprise one or more additively manufactured metal components, and wherein a total mass of the one or more additively manufactured metal components is in a range from 1% to 50% of a total dry mass of the gas turbine engine.

2. The gas turbine engine of claim 1, wherein the gas turbine engine comprises a turboprop engine of 300-8,000 Horsepower.

3. The gas turbine engine of claim 1, wherein the gas turbine engine comprises a ducted turbofan engine configured to provide a range from 3,000 to 125,000 pounds thrust.

4. The gas turbine engine of claim 1, wherein the gas turbine engine comprises an open rotor engine configured to provide a range from 5,000 to 60,000 pounds thrust.

5. The gas turbine engine of claim 1, wherein the gas turbine engine comprises one of a turboprop engine, a ducted turbofan engine, or an open rotor engine each having a design life of greater than at least one of 500 hours or 500 flight cycles before overhaul.

6. The gas turbine engine of claim 1, further comprising one or more sump housings, wherein at least one sump housing of the one or more sump housings comprises at least one additively manufactured metal component of the one or more additively manufactured metal components, and wherein the at least one sump housing has a mass within a range of 1% to 5% of the total dry mass of the gas turbine engine.

7. The gas turbine engine of claim 1, wherein the one or more additively manufactured metal components comprises at least one of a fuel heater, a sump housing, a heat exchanger, a swirler, a fuel nozzle, a gearbox housing, an exhaust case, a combustor liner, an inlet frame, or an inlet screen.

8. The gas turbine engine of claim 1, wherein the one or more additively manufactured metal components comprises at least three different types of additively manufactured metal components.

9. A gas turbine engine, comprising:
a turbomachine comprising a compressor section, a combustion section, and a turbine section arranged in serial flow order, the compressor section having a compressor, the turbine section having one or more turbines; and
wherein the turbomachine comprise one or more additively manufactured metal components, and wherein a total mass of the additively manufactured metal components is at least 1% or greater of a total dry mass of the gas turbine engine.

10. The gas turbine engine of claim 9, further comprising one or more sump housings, wherein at least one sump housing of the one or more sump housings comprises at least one additively manufactured metal component of the one or more additively manufactured metal components, and wherein the at least one sump housing has a mass within a range of 1% to 5% of the total dry mass of the gas turbine engine.

11. The gas turbine engine of claim 9, wherein the one or more additively manufactured metal components comprises at least one of a fuel heater, a sump housing, a heat exchanger, a swirler, a fuel nozzle, a gearbox housing, an exhaust case, a combustor liner, an inlet frame, or an inlet screen.

12. The gas turbine engine of claim 9, wherein the one or more additively manufactured metal components comprises at least one sump housing having an integral de-swirler.

13. The gas turbine engine of claim 9, wherein the one or more additively manufactured metal components comprises at least one inlet frame having an integral inlet screen.

14. The gas turbine engine of claim 9, wherein the one or more additively manufactured metal components comprises at least one sump heat exchanger.

15. The gas turbine engine of claim 9, wherein the gas turbine engine comprises at least one of:
a turboprop engine of 300-8,000 Horsepower;
a ducted turbofan engine configured to provide a range from 3,000 to 125,000 pounds thrust; or
an open rotor engine configured to provide a range from 5,000 to 60,000 pounds thrust.

16. A gas turbine engine, comprising:
a turbomachine comprising a compressor section, a combustion section, and a turbine section arranged in serial flow order, the compressor section having a compressor, the turbine section having one or more turbines, the turbomachine further comprising at least one sump housing; and
wherein the turbomachine comprise one or more additively manufactured metal components, and wherein the one or more additively manufactured metal components includes the at least one sump housing, and wherein a total mass of the at least one sump housing is in a range from 1% to 5% of a total dry mass of the gas turbine engine.

17. The gas turbine engine of claim 16, wherein the at least one sump housing comprises at least one integral de-swirler.

18. The gas turbine engine of claim 16, wherein the one or more additively manufactured metal components includes at least one of a fuel heater, a heat exchanger, a swirler, a fuel nozzle, a gearbox housing, an exhaust case, a combustor liner, an inlet frame, or an inlet screen.

19. The gas turbine engine of claim 16, wherein a total mass of the one or more additively manufactured metal components is in a range from 1.5% to 25% of the total dry mass of the gas turbine engine.

20. The gas turbine engine of claim 16, wherein the gas turbine engine comprises at least one of:
a turboprop engine of 300-8,000 Horsepower;
a ducted turbofan engine configured to provide a range from 3,000 to 125,000 pounds thrust; or
an open rotor engine configured to provide a range from 5,000 to 60,000 pounds thrust.
